(19) United States
(12) Patent Application Publication
(10) Pub. No.: US 2012/0112920 A1
(43) Pub. Date: May 10, 2012

(54) CARBON MONOXIDE AND SMOKE ALARM DEVICE

(76) Inventor: PRADEEP RAMDEO, Bronx, NY (US)

(21) Appl. No.: 13/289,912

(22) Filed: Nov. 4, 2011

Related U.S. Application Data
(60) Provisional application No. 61/409,995, filed on Nov. 4, 2010.

(51) Int. Cl. G08B 17/10

(52) U.S. Cl. 340/628

(57) ABSTRACT

A carbon monoxide and smoke alarm device includes a housing mountable to a ceiling in a building. A carbon monoxide sensor is disposed in the housing to detect an airborne carbon monoxide substance within the building. A smoke sensor is disposed in the housing to detect an airborne smoke substance within the building. An audible alarm module is disposed in the housing to be activated by any one of the sensors. A processor/memory unit is disposed in the housing to be activated by any one of the sensors. A transducer is disposed in the housing to be activated by the processor/memory unit to send a signal to a person at a remote computer and to a person at a cell phone.

### CROSS-REFERENCE TO RELATED APPLICATION

This application claims the benefit of Provisional Patent Application No. 61/409,995, filed on Nov. 4, 2010, In the United States Patent & Trademark Office, the disclosure of which is incorporated herein by reference.

### BACKGROUND OF THE INVENTION

1. Field of the Invention

The present invention relates to a home safety system, and more particularly, a carbon monoxide and smoke alarm device.

Conventional smoke alarms and carbon monoxide detectors are only useful if an individual is home to hear the alarm sound. If the occupants of a building are not present at the time of a fire, the property may be engulfed by the time neighbors notice the smoke. If a structure is not in close proximity to other properties, there may be no notification of the emergency. Individuals may lose all of their belongings in a fire or worse, they may not hear the alarm and may lose their lives. A safer alternative is needed.

The carbon monoxide and smoke alarm device is designed to detect carbon monoxide and smoke and then alert the occupants and emergency services if necessary. The device will not only sound an audible alarm, but will also alert contacts by text message, voice message or other forms of notification. If the situation escalates or the alarm is not acknowledge, emergency services will automatically be notified and provided with the property's address and other vital information. The present invention provides safety by effectively alerting occupants of an emergency. If the owner is not home, the device can remotely notify them and the proper authorities. Consumers will appreciate the safety and efficiency that the device provides.

2. Description of the Prior Art

Numerous innovations for alarm systems have been provided in the prior art that will be described. Even though these innovations may be suitable for the specific individual purposes to which they address, however, they differ from the present invention.

A FIRST EXAMPLE, U.S. Patent Office Publication No. 2005/0151642, Published on Jul. 14, 2005, to Tupler et al. teaches methods, systems and apparatuses for use in providing notification of emergency services as well as notifying additional individuals and/or groups of an emergency. Some embodiments provide methods for use in dispatching emergency services and notifying one or more additional contacts. These methods wirelessly receive a request for emergency services from a remote wireless device, retrieve an emergency contact list according to the type of emergency and determine at least one emergency contact other than emergency services according to the contact list. Once identified, the contact is notified of the request for emergency services. Some embodiments further determine a mode of communicating with the emergency contact and notify the contact according to the mode of communication. Some methods additionally determine one or more types of emergency services to be dispatched and notify types of emergency services.

A SECOND EXAMPLE, U.S. Patent Office Publication No. 2010/0079278, Published on Apr. 1, 2010, to Suzuki et al. teaches a power saving wireless fire alarm system that has a master station and a plurality of battery-powered fire detecting cc terminals linked for wireless communication with each other. Upon detection of a fire occurrence at one of the fire detecting terminals, the fire detecting terminal transmit a fire detection message to a master station which in turn transmit a wake-up message to the other fire detecting terminals and thereafter a fire information message which starts a multiple synchronous communication between the master station and the fire detecting terminals. Each fire detecting terminal has a power controller which selects an intermittent reception mode of activating its own receiver only intermittently until receiving the wake-up message or information indicative of the fire occurrence, and select a constant operation mode thereafter to make the fire detecting terminals be ready for the multiple synchronous communication commenced by the fire information message from the master station.

A THIRD EXAMPLE, U.S. Patent Office Publication No. 2010/0140478, Published on Jun. 10, 2010, to Wilson et al. teaches a gas detector that is arranged to sense the concentration levels of target gases oxygen, methane, carbon monoxide, and hydrogen sulphide, within a gas sample from an environment surrounding the detector. The gas detector comprises laser sources that are arranged to transmit radiation through the gas sample at four target wavelengths that correspond approximately to the optimum absorption wavelengths of each of the target gases and an optical detector that is arranged to sense the intensity of the radiation transmitted through the gas sample at each of the target wavelengths. A control system generates representative concentration level information for the target gases based on the level of absorption of the radiation transmitted.

A FOURTH EXAMPLE, U.S. Patent Office Publication No. 2011/0121968, Published on May 26, 2011, to Hart et al. teaches an alarm system comprising an alarm handset having a housing, a detector circuit having means for receiving a preselected signal from a remote transmitter and generating a first detection signal in response thereto, first sensing means for sensing change in a preselected parameter of the handset, warning means for generating a warning signal, alarm means for generating an alarm signal and control means responsive to receipt of the detection signal to activate the alarm means. The control means is operable to activate the warning means in response to at least one of receipt of the control signal and sensing of the change in the preselected parameter of the handset.

A FIFTH EXAMPLE, U.S. Patent Office Publication No. 2011/0187543, Published on Aug. 4, 2011, to Russo et al. teaches a home safety 911 system which comprises a battery disposed in an enclosure that supplies power to a smoke sensor, a carbon monoxide sensor and a gas leak sensor. An audible alarm module, a visual alarm module and an escape route module are all disposed in the enclosure and can be activated by any one of the sensors. A “FIRE 911” visual alarm display is mounted on at least one window in a house and is remotely activated by the visual alarm module.

It is apparent now that numerous innovations for alarm systems have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a carbon monoxide and smoke alarm device that avoids the disadvantages of the prior art.

ANOTHER OBJECT of the present invention is to provide a carbon monoxide and smoke alarm device that is simple and inexpensive to manufacture.

STILL ANOTHER OBJECT of the present invention is to provide a carbon monoxide and smoke alarm device that is simple to use.

BRIEFLY STATED, STILL YET ANOTHER OBJECT of the present invention is to provide a carbon monoxide and smoke alarm device which comprises a housing mountable to a ceiling in a building. A carbon monoxide sensor is disposed in the housing to detect an airborne carbon monoxide substance within the building. A smoke sensor is disposed in the housing to detect an airborne smoke substance within the building. An audible alarm module is disposed in the housing to be activated by any one of the sensors. A processor/memory unit is disposed in the housing to be activated by any one of the sensors. A transducer is disposed in the housing to be activated by the processor/memory unit to send a signal to a person at a remote computer and to a person at a cell phone.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a block diagram showing the various components of the present invention;

FIG. 2 is a perspective view of the present invention per se;

FIG. 3 is a perspective view showing a person entering information from a personal computer into the present invention;

FIG. 4 is a perspective view showing the present invention sounding an alarm to a person within a home;

FIG. 5 is a perspective view showing a person at work receiving information on a cell phone from the present invention when the alarm is activated; and

FIG. 6 is a perspective view showing a person at an emergency services location being notified by the present invention when the alarm is activated.

### REFERENCE NUMERALS UTILIZED IN THE DRAWING

110 carbon monoxide and smoke alarm device
112 housing of device 110
114 carbon monoxide sensor in housing 112
116 smoke sensor in housing 112
118 audible alarm module in housing 112
120 processor/memory unit in housing 112
122 transducer in housing 112
124 remote computer
126 cell phone
128 USB port on housing 112
130 USB cable
132 personal computer
134 visual alarm module in housing 112
136 test button on housing 112
138 battery in housing 112
140 switch in housing 112
142 socket on housing 112
144 plug on power cord 146
146 power cord
147 person at personal computer 132
148 circular shaped casing for housing 112
150 ceiling in building 152
152 building
154 person in building 152
156 person at work place 158
158 work place
160 person at emergency services location 162
162 emergency services location

### DETAILED DESCRIPTION OF THE PREFERRED EMBODIMENT

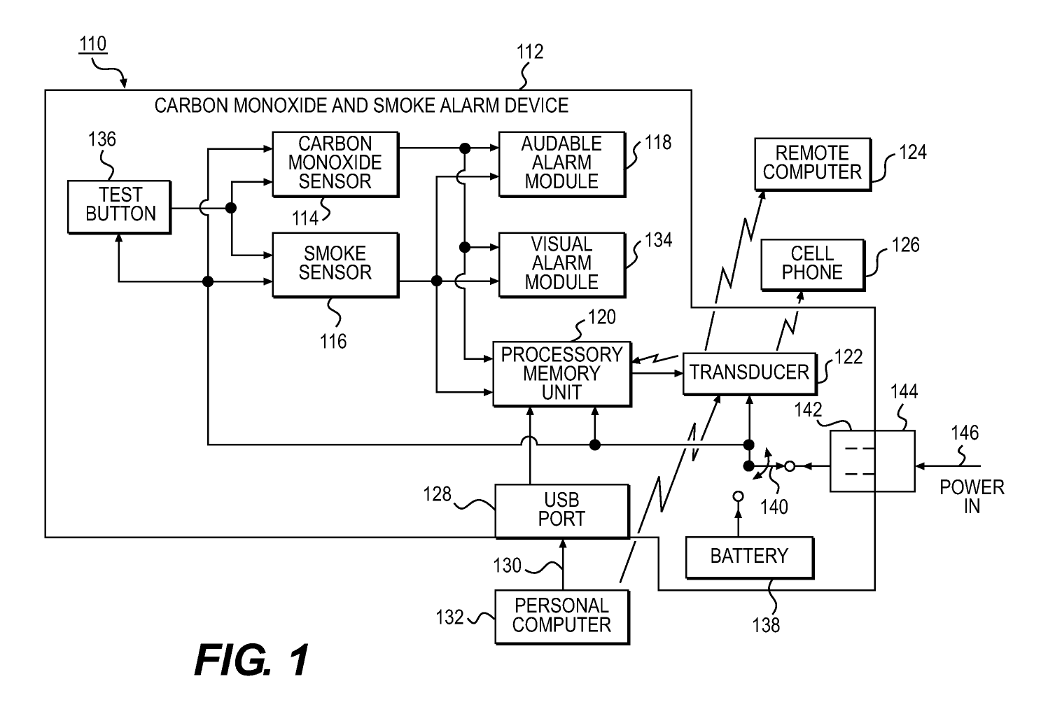

As shown in FIG. 1, the present invention is a carbon monoxide and smoke alarm device 110 which comprises a housing 112. A carbon monoxide sensor 114 is disposed in the housing 112 to detect an airborne carbon monoxide substance. A smoke sensor 116 is disposed in the housing 112 to detect an airborne smoke substance. An audible alarm module 118 is disposed in the housing 112 to be activated by any one of the sensors 114,116. A processor/memory unit 120 is disposed in the housing 112 to be activated by any one of the sensors 114,116. The housing 112 has a round shape with a diameter of 4-5 inches and 1.0-1.5 inches in thickness. A transducer 122 is disposed in the housing 112 to be activated by the processor/memory unit 120 to send a signal to a remote computer 124 and a cell phone 126.

The device 110 further comprises a USB port 128 disposed on the housing 112 to be coupled to the processor/memory unit 120. A USB cable 130 can extend between the USB port 128 and a personal computer 132, so that vital information can be programmed to the processor/memory circuit 120 by using the personal computer 128. A visual alarm module 134 is disposed in the housing 112 to be activated by any one of the sensors 114,116. A test button 136 is disposed on the housing 112 to check the operation of the carbon monoxide sensor 114 and the smoke sensor 116.

A battery 138 is disposed in the housing 112 to supply power to the carbon monoxide sensor 114, the smoke sensor 116, the processor/memory unit 120, the transducer 122 and the test button 136. A switch 140 disposed in the housing 112 is electrically connected to the battery 138. A socket 142 disposed on the housing 112 is electrically connected to the switch 140. A plug 144 on a power cord 146 can engage with the socket 142. When the switch 140 is placed in a first position the battery 138 will supply power. When the switch 140 is placed in a second position the power cord 146 will supply power. The transducer 122 can wirelessly receive the vital information directly from the personal computer 132 and then send the vital information wirelessly to the processor/memory circuit 120.

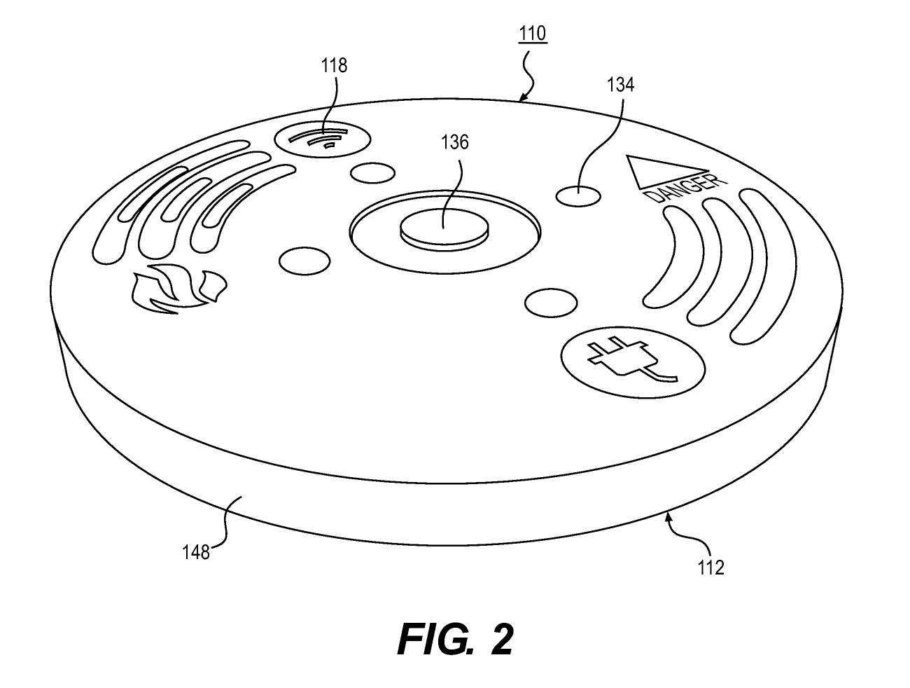

As shown in FIG. 2, the housing 112 is comprised of a circular shaped casing 148 fabricated from a material selected from the group consisting of plastic and metal.

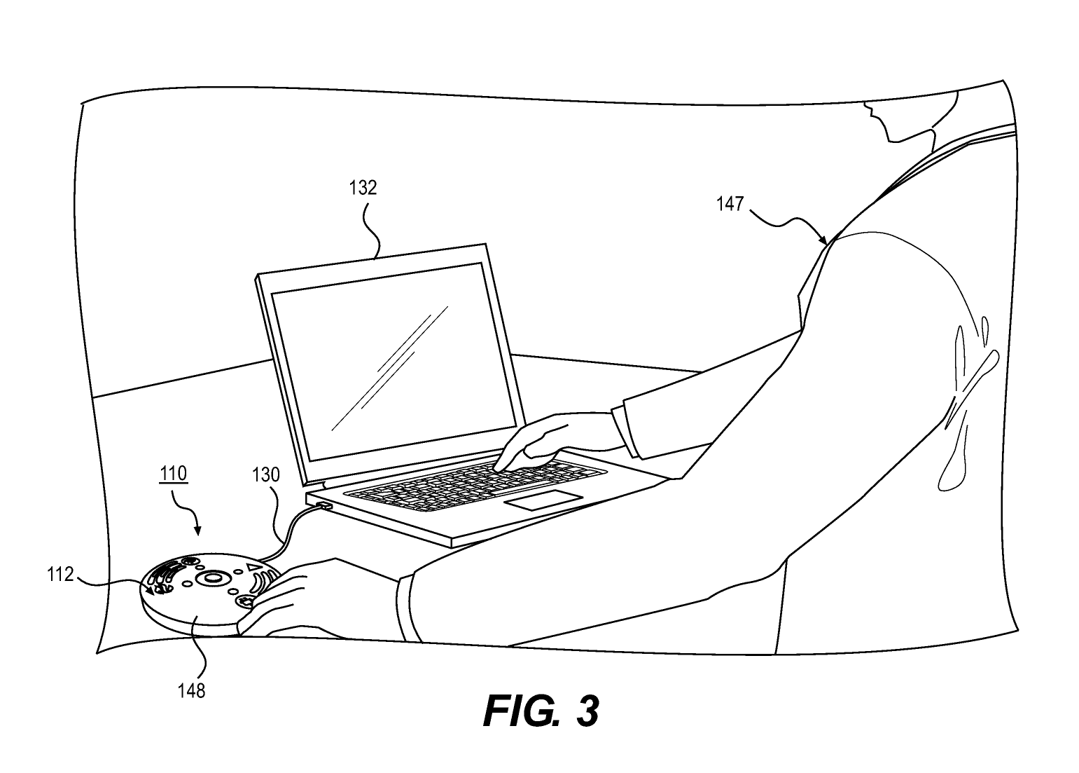

As shown in FIG. 3, a person 147 is entering the vital information into the personal computer 132, so that the vital information can be programmed into the processor/memory circuit 120 within the housing 112 of the device 110.

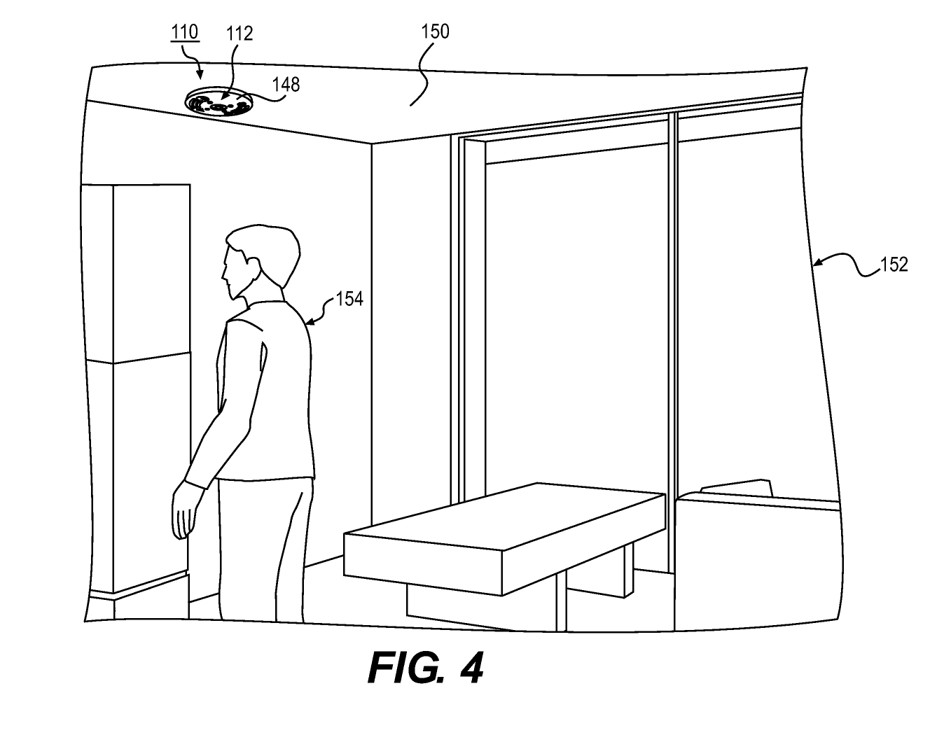

As shown in FIG. 4, the housing 112 can be mountable to a ceiling 150 in a building 152, such as in abasement of a house. The device 110 is sounding an alarm to a person 154 in the building 152.

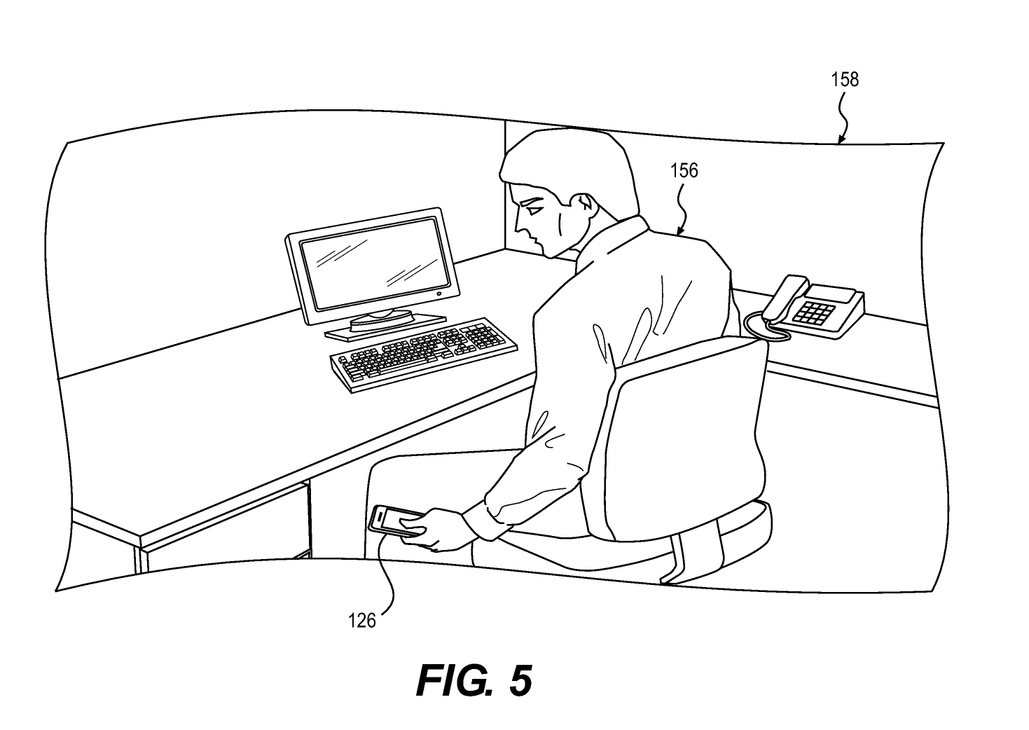

As shown in FIG. 5, the vital information from the device 110 is also being sent to the cell phone 126, so that a person 156 at a work place 158 can be alerted to an emergency.

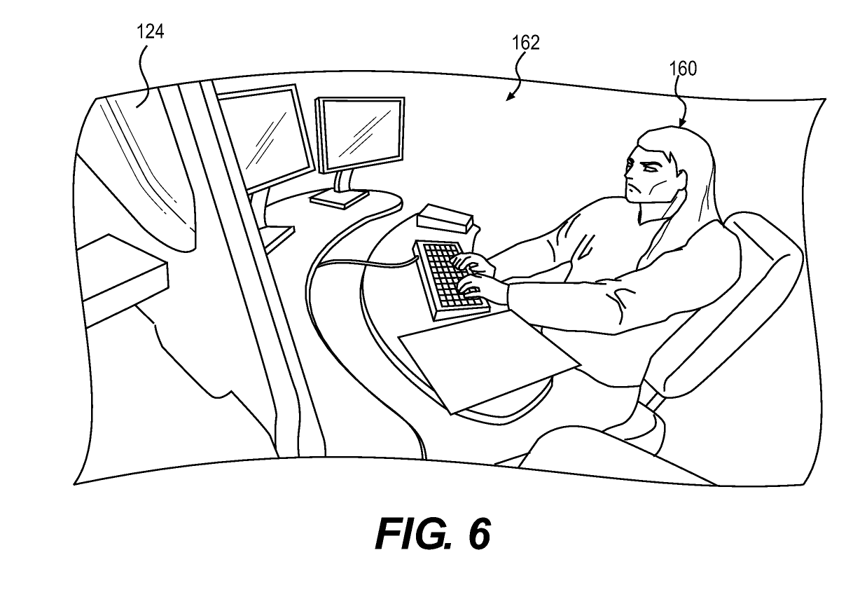

As shown in FIG. 6, the vital information from the device 110 is being sent to the remote computer 124, so that a person 160 at an emergency services location 162 can be alerted to the situation to promptly react and send emergency units to the building 152.

The device 110 may have more than one different alarm tones, one for the smoke sensor 116 and one for the carbon monoxide sensor 114. The visual alarm module 134 may also include LED lights of different colors for the hearing impaired. The device 110 can be wired to send text message, voice messages, or emails to different phone numbers and addresses or other forms of notification. A list of contacts may be uploaded onto the device 110 via the USB cable 130. Multiple devices 110 may be connected to one another so that when one sounds, the others are also activated. Some devices 110 may just be designed to detect smoke or just carbon monoxide. The device 110 may utilize a Wi-Fi network, cellular phone towers, or other methods of communication. Some commercial models may contain a speaker and the ability for someone to announce instructions if there is a fire, Another models may be able to detect cause of fire for example electrical, combustible [gasoline], explosive, temperature and relay that information to emergency services. Another model of CMS Alarm & Transmitter may be designed to detect other types of gases or vapors for example [natural gas, methane gas] and function in a similar way. Some models maybe designed for specific industries like hotels, motels cruise ships and etc. alarm may be set for loud or silent where the proper authority within the building [fire command] will be notified first. The exact specifications may vary.

It will be understood that each of the elements described above, or two or more together, may also find a useful application in other types of constructions differing from the types described above.

While the invention has been illustrated and described as embodiments of carbon monoxide and smoke alarm device, accordingly it is not limited to the details shown, since it will be understood that various omissions, modifications, substitutions and changes in the forms and details of the device illustrated and its operation can be made by those skilled in the art without departing in any way from the spirit of the present invention. Features, shape, size, color, sound and etc. may vary with each model, as technology advances features may be added or removed to improve CMS Alarm & Transmitter.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A carbon monoxide and smoke alarm device which comprises:
a) a housing mountable to a ceiling in a building;
b) a carbon monoxide sensor disposed in the housing to detect an airborne carbon monoxide substance within the building;
c) a smoke sensor disposed in the housing to detect an airborne smoke substance within the building;
d) an audible alarm module disposed in the housing to be activated by any one of the sensors;
e) a processor/memory unit disposed in the housing to be activated by any one of the sensors; and
f) a transducer disposed in the housing to be activated by the processor/memory unit to send a signal to a person at a remote computer and to a person at a cell phone.

2. The device as recited in claim 1, further comprising a USB port disposed on the housing to be coupled to the processor/memory unit, whereby a USB cable can extend between the USB port and a personal computer, so that a person can program vital information to the processor/memory circuit using the personal computer.

3. The device as recited in claim 1, further comprising a visual alarm module disposed in the housing to be activated by any one of the sensors.

4. The device as recited in claim 1, further comprising a test button disposed on the housing to check the operation of the carbon monoxide sensor and the smoke sensor.

5. The device as recited in claim 4, further comprising a battery disposed in the housing to supply power to the carbon monoxide sensor, the smoke sensor, the processor/memory unit, the transducer and the test button.

6. The device as recited in claim 5, further comprising:
a) a switch disposed in the housing electrically connected to the battery; and
b) a socket disposed on the housing electrically connected to the switch, whereby a plug on a power cord can engage with the socket, so that when the switch is placed in a first position the battery will supply power and when the switch is placed in a second position the power cord will supply power.

7. The device as recited in claim 2, wherein the transducer can wirelessly receive the vital information directly from the personal computer and then send the vital information wirelessly to the processor/memory circuit.

8. The device as recited in claim 1, wherein the housing is comprised of a circular shaped casing fabricated from a material selected from the group consisting of plastic and metal.

9. The device as recited in claim 1, wherein the housing has a circular shape with a diameter of 4-5 inches and 1.0-1.5 inches in thickness.
